(19) United States
(12) Patent Application Publication
(10) Pub. No.: US 2009/0321991 A1
(43) Pub. Date: Dec. 31, 2009

(54) MOLD FOR MAKING A MASONRY BLOCK AND METHOD FOR MAKING A MASONRY BLOCK

(76) Inventor: Gino P.N. Caroti, Wilton, CT (US)

Correspondence Address: COCHRAN FREUND & YOUNG LLC, 2026 CARIBOU DR, SUITE 201, FORT COLLINS, CO, 80525, US

(21) Appl. No.: 12/486,861

(22) Filed: Jun. 18, 2009

Related U.S. Application Data
(60) Provisional application No. 61/075,688, filed on Jun. 25, 2008.

(51) Int. Cl. B29C 39/02; B28B 7/26

(52) U.S. Cl. 264/299; 249/124

(57) ABSTRACT

A mold for making a masonry block having a non-planar lower surface. The mold includes a pair of opposing side walls, a pair of opposing end walls, and a top forming an upper member, and a removable bottom member. The removable bottom member is configured to provide the non-planar configuration of the lower surface of the block when the block is cast in the mold. A method for making a masonry block having a non-planar lower surface is also disclosed. The method includes providing the mold which has the removable bottom member configured to provide the non-planar configuration of lower surface of the block when the block is cast in the mold, charging a masonry mix to the mold to form the block, curing the block, and removing the removable bottom from the mold.

### CROSS-REFERENCE TO RELATED APPLICATION

This application is based upon and claims the benefit of U.S. provisional application No. 61/075,688, entitled “Mold for Making a Masonry Block and Method for Making a Masonry Block”, filed Jun. 25, 2008, by Gino P. N. Caroti, the entire disclosure of which is hereby specifically incorporated by reference for all that it discloses and teaches.

### BACKGROUND OF THE INVENTION

This invention relates to masonry blocks and, more specifically, relates to a method and an apparatus for making masonry blocks.

### BRIEF SUMMARY OF THE INVENTION

Masonry blocks, i.e., building blocks commonly known as concrete blocks or cinder blocks, are made by making an appropriate mix, charging the mix into a mold, curing the mix, and ejecting the formed block from the mold. One method and apparatus for making such a block is described in U.S. Pat. No. 7,360,910, issued on Apr. 22, 2008, to Woolford et al., and incorporated herein in its entirety, including the drawings, by reference.

The method and apparatus described by Woolford et al. is for making a block having a bottom surface which is planar and can be ejected from the mold by sliding it out. Such a method and apparatus cannot be used to make a block which does not have a planar bottom surface such as the block taught by Gino P. N. Caroti in U.S. Pat. No. 4,956,958, issued on Sep. 18, 1990, which is incorporated herein in its entirety, including the drawings, by reference. This block is hereafter referred to as the “Caroti block”.

Generally, the Caroti block is a building block or brick having two vertical end surfaces and two vertical side surfaces, a top surface having a plurality of dihedral projections extending along the longitudinal length of the block and a bottom surface which has a plurality of dihedral recessions also running along the longitudinal length of the block. Because of the dihedral projections and recessions, the blocks are autofitting to the extent that when a wall is constructed, the weight of the wall itself helps to press the projections and recessions into engagement with each other, thus increasing the stability and firmness of the wall.

The bottom surface of the block has at least one more dihedral recession than the upper surface has dihedral projections. Vertical grooves, preferably semicircular in shape, can be provided in the vertical end surfaces of the brick in communication with this extra recession. Therefore, when a wall of such blocks is constructed, adjacent grooves form a vertical channel through which grout can be poured.

It will be appreciated that the non-planar configuration of the lower surface of the Caroti block, or any other block with a non-planar bottom surface, cannot be ejected from a mold by simply sliding it out because the bottom of the mold is shaped to cast the required dihedral projections in the lower surface of the block.

In order to facilitate ejection of the block from the mold, the bottom of the mold of the present invention comprises a tray conformed in its upper surface to the particular irregularity of the bottom surface of the block. But since the lower surface of the tray, is perfectly flat, once the block is cast, the tray carrying the block is removed from the mold body. Once the block is cured and set it is removed from the tray and the tray is then cycled back to form another block. The tray is not merely a support for the mold, it is an integral part of the mold taking up approximately ten percent of the mold volume, although that percentage can vary depending on the dimensions of the dihedral projections or, in the case of a block other than the Caroti block, depending on the configuration of the block. Thus the tray which forms the dihedral projections on the lower surface of the block will have sufficient height to form the dihedral projections from their peaks to their valleys. The tray has four lateral walls which form part of the mold.

### BRIEF DESCRIPTION OF THE DRAWINGS

FIG. 1 is a perspective view of Caroti's solid building block from which a hollow block according to FIG. 2 is derived;

FIG. 2 is a perspective view a hollow building block according to Caroti's fourth embodiment;

FIG. 3 is a perspective view of the mold of the instant invention with a solid Caroti block shown in phantom located within the mold;

FIG. 4 is a longitudinal cross-section of the mold of FIG. 3 along the line 4-4 of FIG. 3;

FIG. 5 is a partially exploded perspective view of the mold of FIG. 3;

FIG. 6 is a perspective view of a partially open mold of the instant invention shown on a conveyor; and

FIG. 7 is a perspective view of the bottom tray of the mold of the instant invention at the time of removal of the block from the mold.

### DETAILED DESCRIPTION OF THE INVENTION

While this invention is susceptible to embodiments in many different forms, there is shown in the drawings and will be described herein, in detail, specific embodiments thereof with the understanding that the present disclosure is to be considered as an exemplification of the principles of the invention and is not to be limited to the specific embodiments described.

Before describing the mold and method of the present invention, it is helpful to first consider a block or brick of the type to be cast using the present mold. The Caroti block is a good example of such a block although the present invention may be used to make any type of block or brick with a non-planar bottom such as, for example, that described in U.S. Pat. No. 5,623,797 in the name of Gravier et al., which is incorporated herein by reference in its entirety.

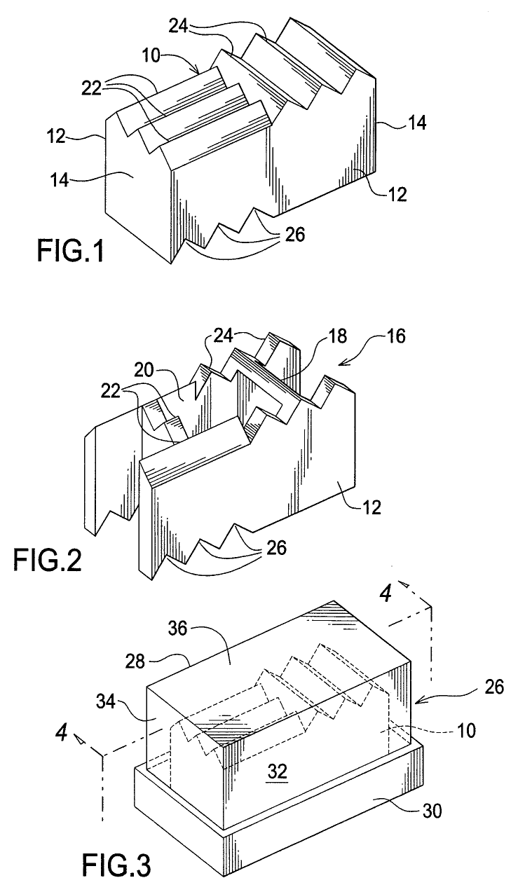

The configuration of the Caroti block can be understood from his fourth embodiment as shown in the instant FIGS. 1 and 2. FIGS. 1 and 2 show essentially the same configuration, the only difference being that the block of FIG. 1 is solid while the block of FIG. 2 is hollow.

The block generally designated by the numeral 10 in FIG. 1 comprises two opposed side walls 12 and two opposed end walls 14. Similarly, the hollow block 16 of FIG. 2 has two opposed side walls.

The hollow block of FIG. 2 has at least two crosspieces or webs 18 extending between the side walls 12 to define at least one hollow space 20 therebetween. The side walls 12 and crosspieces 18 define upper and lower surfaces. Similarly, the solid block of FIG. 1 has upper and lower surfaces. The upper and lower surfaces of FIGS. 1 and 2 will now be described.

The upper surface is angled so as to form three dihedral projections 22 extending longitudinally along half of the upper surface, and three dihedral projections 24 extending transverse to the block along the other half of the upper surface. The lower surface has three dihedral recessions (not shown) extending longitudinally along one half of the lower surface, and three dihedral recessions 26 extending transverse to the block along the other half of the lower surface. Thus, the bottom of one such block mates with the top of another such block in a “male-female” fashion.

As mentioned earlier, it will be appreciated that the non-planar configuration of the lower surface of the Caroti block, or any other block with a non-planar bottom surface, can not be ejected from a mold by simply sliding it out because the bottom of the mold is shaped to cast the required dihedral projections in the lower surface of the block.

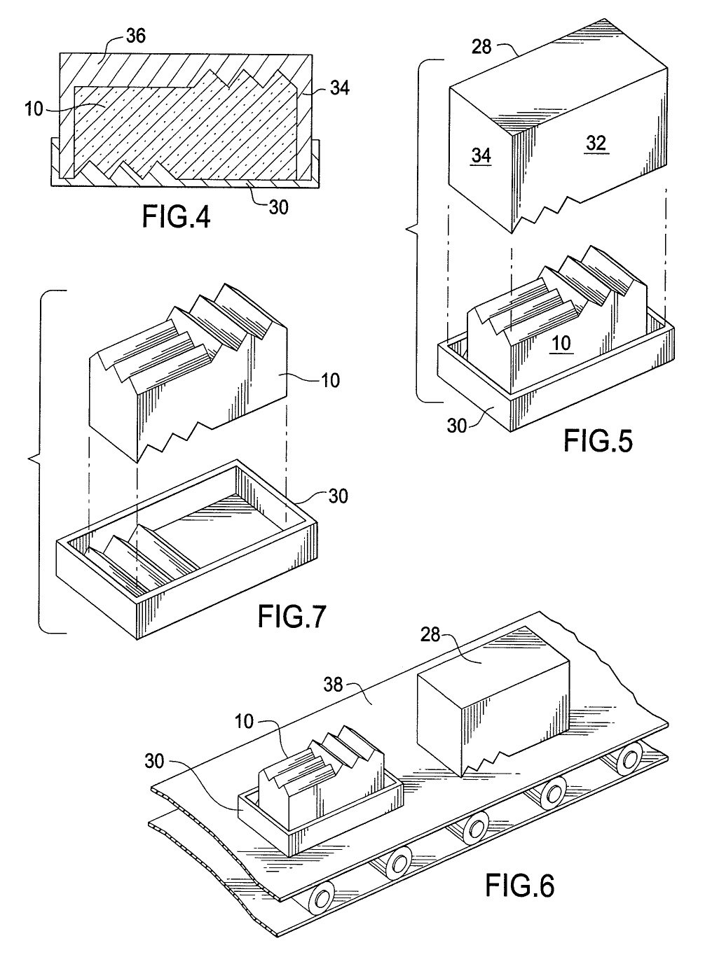

Turning to FIG. 3, there is depicted a mold generally designated by the numeral 26 comprising an upper mold piece 28 and a lower mold element, or tray, 30. The upper mold piece 28 comprises a pair of opposed sides 32, a pair of opposed ends 34, and a top 36. Top 36 has an inner surface configured to create dihedral projections 22 and dihedral projections 24 when the mix is charged to the mold as shown in FIG. 4.

In order to facilitate ejection of the block from the mold, the bottom 30 of the mold 26 comprises a tray formed to make the irregular bottom surface of the block. This feature is seen more clearly in FIG. 4.

After the block is cast and cured, the tray 30 is removed from the mold body, or the upper member 28 is removed from the mold as seen in FIG. 5 and the block removed from the tray as shown in FIG. 6, where the mold is shown on a conveyor 38, and FIG. 7. The tray is then cycled back to the mold body to form another block. The tray is not merely a support for the mold, it is an integral part of the mold taking up approximately ten percent of the mold volume, although that percentage can vary depending on the dimensions of the dihedral projections. Thus the tray which forms the dihedral projections on the lower surface of the block will have sufficient height to form the dihedral projections from their peaks to their valleys. The tray has four lateral walls which form part of the mold.

It will be appreciated that while the block shown in FIGS. 3 through 7 is the solid Caroti block, the mold of the present invention could as well be used to make the hollow Caroti block or any other block having a non-planar bottom surface.

The method of the present invention for making the building blocks comprises constructing a mold having a bottom tray for forming dihedral projections, or other non-planar surface on the bottom of a block, casting the block in the mold, and removing the tray from the mold body.

Many modifications of the above described embodiments are possible without departing from the spirit and scope of the invention. For example, any number of dihedral projections and recessions can be used, the size and shape of which can be varied. The shape of the vertical channels can be varied. Therefore, the scope of the invention is measured not by the disclosed embodiments, but by the appended claims.

What is claimed is:

1. A mold for making a masonry block having a non-planar lower surface, said mold comprising a pair of opposing side walls, and a pair of opposing end walls, and a top forming an upper member, and a removable bottom member, said removable bottom member being configured to provide the non-planar configuration of the lower surface of the block when the block is cast in the mold.

2. A mold according to claim 1, wherein said non-planar lower surface of said block comprises a plurality of dihedral projections extending longitudinally along at least a part of said lower surface of said block and a plurality of dihedral projections extending transversely along at least a part of said lower surface of said block, and said removable bottom member is configured to form said dihedral projections when said block is cast in said mold.

3. A mold according to claim 2, wherein said removable bottom member comprises approximately 10% of the volume of said mold.

4. A method for making a masonry block having a non-planar lower surface comprising providing a mold as defined in claim 1, said method comprising charging a masonry mix to said mold to form said block, curing said block, and removing said removable bottom member from said mold.

5. A method according to claim 4, wherein said non-planar lower surface of said block comprises a plurality of dihedral projections extending longitudinally along at least a part of said lower surface of said block and a plurality of dihedral projections extending transversely along at least a part of said lower surface of said block.

6. A method according to claim 4, wherein said removable bottom member comprises approximately 10% of the volume of said mold.
